(19) United States
(12) Patent Application Publication
(10) Pub. No.: US 2009/0132282 A1
(43) Pub. Date: May 21, 2009

(54) MEDICAL DATA MANAGEMENT

(75) Inventors: Jurgen Kerstna, Jarfalla (SE); Patrik Malmberg, Stockholm (SE)

Correspondence Address: SCHIFF HARDIN, LLP;PATENT DEPARTMENT, 6600 SEARS TOWER, CHICAGO, IL, 60606-6473, US

(73) Assignee: ST. JUDE MEDICAL AB., JARFALLA (SE)

(21) Appl. No.: 12/091,128

(22) PCT Filed: Oct. 25, 2005
(86) PCT No.: PCT/SE05/01601

§ 371 Date: Apr. 22, 2008

(51) Int. Cl. G06Q 50/00

(52) U.S. Cl. 705/3

(57) ABSTRACT

For exchanging medical data in a healthcare system having multiple patient domains, with at least one of these domains being isolated from the other domains by virtue of a patient identifier for the other domains not having access to patient identifiers used by the isolated domain, patient-related data for a given patient are provided and are sent to this manager. The manager compares the data with stored data to identify an identifier of the given patient utilized by one of the other domains. This identifier is returned to the isolated domain, wherein it is employed for enabling an association of locally or externally generated medical data of the patient with an externally or locally utilized identifier of the patient with an externally or locally utilized identifier of the patient. The isolated domain may utilize model and serial numbers of implantable medical devices as the patient identifiers.

### BACKGROUND OF THE INVENTION

1. Field of the Invention

The present invention generally relates to management of medical data in healthcare systems and in particular to the management of medical data and patient identifiers originating from different patient domains within such healthcare systems.

2. Description of the Prior Art

Inability to link medical data belonging to a patient is one of the big problems that holds back healthcare system integration and provision of the full patient medical history to the clinician. In order to solve these problems, Integrating the Healthcare Enterprise (IHE) has defined the specifications called Technical Framework [1] Integrating the Healthcare Enterprise (IHE), IT Infrastructure, Technical Framework, Volume 1 (ITI TF-1), Integration Profiles, Revision 2.0, Aug. 15, 2005 [2] Integrating the Healthcare Enterprise (IHE), IT Infrastructure, Technical Framework, Volume 2 (ITI TF-2), Transactions, Revision 2.0, Aug. 15, 2005 to promote the integration of information systems that support modern healthcare institutions. Its fundamental objective is to ensure that in the care of patients all required information for medical decisions is accurate and available to healthcare professionals. The Technical Framework defines how patient identity can be cross-referenced between different countries, hospitals and other types of healthcare-affinity domains. Patient Identifier Cross-referencing (PIX) is an integration profile of IHE Technical Framework that provides cross-referencing of patient identifiers from multiple patient identifier domains. These patient identifiers can then ideally be used by identity consumer systems to correlate information about a single patient from sources that know the patient by different identifiers.

The PIX integration profile is targeted at healthcare enterprises of a broad range of sizes (hospital, a clinic, a physician office, etc.). It supports the cross-referencing of patient identifiers from multiple patient identifier domains via the following interactions:

The transmission of patient identity information from an identity source to the PIX manager.

The ability to access the list(s) of cross-referenced patient identifiers either via a query/response or via update notification.

The PIX integration profile mentioned above and other integration profiles employed in the prior art for cross-reference patient identifiers between different patient (identifier) domains within the healthcare system are all dependent on a central PIX manager that has access to the patient identifiers utilized locally within the different patient domains. Thus, if the PIX manager does not have access to the patient identifiers employed in a particular patient domain, no integration of medical data originating from this domain with corresponding medical data from external domains nor any access, by an external domain, to the medical data stored in the particular relevant patient domain is possible according to the prior art techniques.

Pacemaker, implantable cardioverter defibrillator (ICD) and other implantable medical device (IMD) programmers typically identify the patient based on the serial and model number of the IMD. These programmers can receive information of various operational parameters of the IMD and physiological and diagnostic data collected by the IMD. In the line with discussion above, there is a need to integrate this kind of data produced by the programmer (and received from the IMD) with other medical data that might be captured with other medical equipment in order to provide a unified patient medical record. In these cases of data exchange, by employing the prior art PIX technique, the device serial and model number must be stored in the PIX manager and mapped to the patient identifiers utilized by other patient domains. However, in most countries the device serial and model numbers are only employed locally in the programmer-IMD domain and are not known to external domains, including the PIX Manager.

Furthermore, it would be very time and cost consuming, if not practically impossible, to develop the software component for the programmer, which makes the circumstantial automatic mapping whenever the programmer needs to exchange data with other systems. Another problem in this context is the ambiguity of using the device serial and model number as a patient identifier because the patients regularly get new devices, with new serial and model numbers. Another issue is regulatory demand for patient data security, which does not allow registration of all patient demographic data needed to identify the patient in the programmer.

### SUMMARY OF THE INVENTION

The present invention overcomes these and other drawbacks of the prior art arrangements.

It is a general object of the present invention to enable exchange of medical and clinical patient data between patient domains in a healthcare system.

It is another object of the invention to provide such a medical data exchange in a healthcare system where the patient identifiers utilized by one of the patient domains are not known to the other units and domains of the system.

Yet another object of the invention is to provide a complement to existing healthcare integrations schemes to promote and simplify the healthcare system integration and provision of the full patient medical history to the clinician.

Briefly, the present invention involves management of data in healthcare systems and in particular to management of medical data and patient identifiers originating from different patient domains within such healthcare systems.

The present invention relates to managing medical patient data and clinical data in a healthcare system comprising at least a first and a second patient domain and a patient identifier manager. The patient identifier manager has access to domain-dedicated patient identifiers utilized by the second domain for identifying its patients and customers. In addition, the patient identifier manager associatively stores these patient identifiers together with patient-related and demographic data describing the patients. Thus, neither the patient identifier manager nor the second patient domain has access to the domain-dedicated patient identifiers employed locally within the first domain, or the first domain may actually not use patient identifiers for identification of its patients.

According to the invention, patient-related data of a given patient are provided in the first patient domain. The patient-related data may be demographic data or other data associated with and describing the given patient for which a physician wants to access the corresponding identifier used by the second patient domain for the patient, or for which the physician wants to access medical data stored in the second domain.

The provided patient-related data are employed as an input in a request for a patient identifier associated with the patient and utilized by the second patient domain. This patient identifier request is sent from the first patient domain to the patient identifier manager, preferably through secure (encrypted) communication.

The patient identifier manager retrieves the patient-related data from the request and uses the data for identifying the requested patient identifier domain. The patient identifier manager typically has a database or other storage facility, in which the patient identifiers and patient-related data for the patients of the second domain are stored, Once the patient identifier manager has found the requested patient identifier, it returns it to the first patient domain, preferably by means of secure communication.

The first patient domain utilizes the received patient identifier for associating medical data of the given patient originating from the own (first) domain or the external (second) domain with a patient identifier of the given patient utilized in the external (second) or own (first) domain. This means that the received patient identifier is used to associate medical patient data from one of the first and second patient domain with a patient identifier utilized by the other of the first and second patient domain.

In a preferred embodiment of the present invention, the first patient domain associates local medical data originating from, or at least stored within, the first domain with the received (external) patient identifier. As a consequence, medical and/or clinical data of the given patient from the first domain will be associated with an identifier of the patient and utilized by an external (the second) patient domain. This means that medical data generated and found in the first domain is now, through the association with the external patient identifier that is also found in the patient identifier manager, accessible by the external domains. This embodiment of the present invention, thus, allows external domains to access medical data from the (isolated) patient domain.

In another preferred embodiment of the present invention, the first patient domain requests, from the second domain and based on the received patient identifier, medical data of the given patient and found in the second domain. The second domain identifies and provides the requested medical data and returns it to the first domain, preferably through secure communication. The first domain associates the received medical data with a patient identifier of the given patient and utilized locally within the first patient domain. In this embodiment of the invention, medical data generated and/or stored in an external domain can be accessed by the isolated patient domain. The association between the external medical data and the local domain-dedicated patient identifier allows a physician in the first domain to subsequently access the patient data in a storage using only the local identifier of the patient.

The principle of requesting a patient identifier for a given or current patient, which is utilized by an external domain, can of course be applied to a healthcare system that comprises more than two patient domains. For example, if the healthcare system comprises N different patient domains that utilize different patient identifiers, the patient identifier manager has access to the patient identifiers of M of these N patient domains, where 1≦M≦N−1.

The isolated patient domain can advantageously be realized as a patient domain that manages implantable medical devices (IMDs). In such a domain, the device model and serial number is typically utilized as domain-dedicated patient identifier. However, in most countries the device model and serial numbers are not known to nor used by external domains and patient identifier managers. As a consequence, such IMD-based patient domains are currently isolated from other domains and cannot in an efficient manner participate in the exchange of medical data and integration of healthcare domains according to the prior art techniques.

The present invention removes this isolation and thereby promotes the integration of patient domains within healthcare systems.

The invention offers the following advantages:

Enables an exchange of medical patient data between all patient domains within a healthcare system;

Removes the isolation of certain patient domains by allowing also these domains to participate in the exchange of medical data even though no external domain or unit have access to its patient identifiers;

Promotes the integration of information and data exchange systems in healthcare system;

Can be utilized as a complement to existing patient identity cross-referencing and data exchange scheme; and

Does not require a breach of rules or regulations regarding storage and manage of sensitive patient-related data.

Other advantages offered by the present invention will be appreciated upon reading of the below description of the embodiments of the invention.

### BRIEF DESCRIPTION OF THE DRAWINGS

FIG. 1 is a flow diagram illustrating an embodiment of a method of managing medical patient data according to the present invention.

FIG. 2 is a flow diagram illustrating an embodiment of the associating step of FIG. 1 in more detail,

FIG. 3 is a flow diagram illustrating another embodiment of the associating step of FIG. 1 in more detail.

FIG. 4 is a flow diagram illustrating an embodiment of the data providing step of FIG. 1 in more detail.

FIG. 5 is a flow diagram illustrating an embodiment of the identifier requesting step of FIG. 1 in more detail.

FIG. 6 is a signal diagram schematically illustrating the data signaling between different actors in a healthcare system according to an embodiment of the present invention.

FIG. 7 is a signal diagram schematically illustrating the data signaling between different actors in a healthcare system according to another embodiment of the present invention.

FIG. 8 is a schematic block diagram of an embodiment of a healthcare system according to the present invention.

FIG. 9 is a schematic block diagram of an embodiment of a data manager according to the present invention.

FIG. 10 schematically illustrates a search query with illustrative patient-related data that can be used according to the present invention.

FIG. 11 schematically illustrates a possible implementation of a data manager according to the present invention within a programmer that can communicate with an implantable medical device.

FIG. 12 is a schematic block diagram of another embodiment of a healthcare system according to the present invention.

### DESCRIPTION OF THE PREFERRED EMBODIMENTS

Throughout the drawings, the same reference characters will be used for corresponding or similar elements.

The present invention generally relates to management of data in healthcare systems and in particular to management of medical data and patient identifiers originating from different patient domains within such healthcare systems.

In order to facilitate understanding of the present invention, a description of the healthcare system, in which the present invention can be implemented, first follows herein.

A healthcare system according to the present invention comprises or is regarded as composed of multiple, i.e. at least two, so-called patient domains or patient identifier domains. Such a patient domain is defined as a single sub-system or set of interconnected sub-systems that all share a common identification scheme for assigning identifiers to patients and for identifying patients within the domain.

According to the Technical Framework of the Integrating the Healthcare Enterprise (IHE described above), a patient domain typically has a set of policies that describe how identifiers will be defined and managed according to the specific requirements of the domain. A patient domain also typically comprises an administration authority for administering identity-related policies within the domain.

Such a patient domain may range from large entities and healthcare enterprises, e.g. including hospitals and healthcare facilities in a country or a region of a country, a single hospital, a clinic or department/unit in a hospital or healthcare facility or even a single physician's office.

It is therefore evident for the skilled person that the size of a patient domain in terms of number of patients treated, examined and managed within the domain does not affect the teachings of the present invention. The relevant issue is that within such a domain a given patient is preferably uniquely identifiable by means of a patient identifier or, more seldom multiple patient identifiers. As a consequence, a patient that is customer in multiple patient domains is typically associated with different patient identifiers in the different domains.

In a healthcare system as disclosed above, the IHE has defined specifications to, among others, promote and enable exchange of medical patient data between the different healthcare facilities in the system. In the specifications identified above, a procedure denoted Patient Identifier Cross-reference (PIX is described and employed as tool for implementing this medical data exchange. As a prerequisite, the PIX procedure need a central PIX manager that stores and manages the different patient identifiers utilized by all the patient domains and healthcare facilities in the system.

The invention is based on the insight that the PIX procedure actually will fail for some patient domains, implying that an efficient exchange of medical or clinical data in the system is not obtainable by using the prior art PIX process. For example, if the central PIX manager does not have access to the patient identifiers of a particular domain that domain becomes isolated from the rest of the system domains. As a consequence, a physician in the isolated domain typically cannot, by employing the prior art PIX procedure, access medical data of one of his/her patients and collected and stored in another patient domain employing another patient identifier for the current patient. In addition, no external patient domain can access medical data found in the isolated patient domain since neither the external domain nor the PIX manager know the local patient identifiers utilized in the isolated domain.

The reason for this unavailability of domain-dedicated patient identifiers may be numerous. Firstly, the relevant patient domain may be rather recently established so that it has not yet developed a routine for transmission of its patient identifiers to the central PIX manager. Furthermore, (national and/or ethical) rules and regulations may actually prevent a particular patient domain from distributing its patient identifiers to other domains and units, including the PIX manager, in the healthcare system. For example, programmers for pacemakers, implantable cardioverter defibrillators (ICDs) and other implantable medical devices (IMDs) typically identify a patient based on model and serial number of the IMD implanted in the patient. Even though model and serial numbers are used locally as patient identifiers within patient domains incorporating the programmers and IMDs, in most countries, the device model and serial numbers are not known to, nor used by, external domains and units, including the PIX manager.

The above-identified limitations and problems with the prior art are not limited to PIX-based systems and procedures but are also found in other non-PIX-based systems and procedures for medical data management in healthcare systems comprising multiple patient domains utilizing different patient identifiers.

The present invention relates to methods and arrangements for managing medical patient data and clinical data in a healthcare system comprising at least a first and a second patient domain and a patient identifier manager. The patient identifier manager has access to domain-dedicated patient identifiers utilized by the second domain for identifying its patients and customers. In addition, the patient identifier manager associatively stores these patient identifiers together with patient-related and demographic data describing the patients. Thus, neither the patient identifier manager nor the second patient domain has access to the domain-dedicated patient identifiers employed locally within the first domain, or the first domain may actually not use patient identifiers for identification of its patients.

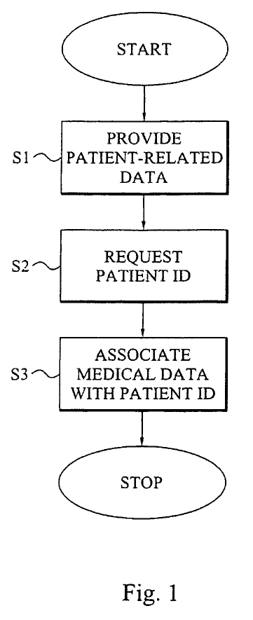

FIG. 1 is a flow diagram illustrating a method of managing medical patient data according to the present invention. The method starts in step S1, where patient-related data of a given patient is provided in the first patient domain. The patient-related data may be demographic data or other data associated with and describing the given patient for which a physician or other user in the first domain wants to access the corresponding identifier used by the second patient domain for the given patient or for which the physician/user wants to access medical data collected/stored in the second domain.

The patient-related data should, as accurately as possible, uniquely describe the given patient. Example of suitable such patient-related data that can be employed according to the present invention is given further below.

The patient-related data may be obtained from the physician's patient file or from the patient itself, who may e.g. give his/her name and contact information to the physician. At least a portion of the data can be obtained from other patient-related data sources, including storage locations and databases, as described further herein. However, due to regulatory demands for patient data security, programmers and other arrangements that can be employed for implementing the present invention may typically not store all patient demographic data needed to unambiguously identify a patient. As a consequence, another patient data source, e.g. the patient itself or the physician is typically needed.

In a next step S2, the provided patient-related data is employed as input in a request for an identifier associated with the given patient and utilized by the second patient domain. This patient identifier request is sent from the first patient domain to the patient identifier manager, preferably through secure (encrypted) communication.

The patient identifier manager retrieves the patient-related data from the request and uses the data for identifying the requested patient identifier domain. The patient identifier manager typically has a database or other storage facility, in which the patient identifiers and patient-related data for the patients of the second domain are stored. For example, the patient identifier and patient-related data of the patients may be found as entries in a list or dedicated database. The main issue in this context is that the patient identifier manager associatively stores the patient identifier(s) for a patient and his/her patient-related data in the storage. The expression “associatively storing” is referred to, in the present description, storing the patient identifier and the patient-related data in such a way that it is possible to later retrieve the patient identifier based on knowledge of the patient-related data and/or vice versa A typical example of associatively storage is when the patient identifier and the patient-related data are stored together as a data entry in a database of the patient identifier manager. Furthermore, the patient identifier and the patient-related data may be stored at different locations within the database or in two different databases, as long as there is a connection, such as a pointer, between the different storage locations. This connection (pointer) enables the patient identifier manager to retrieve the patient identifier from the database based on a matching procedure involving the received patient-related data in the request and the patient-related data stored in the database.

This matching of patient-related data for the purpose of identifying the correct requested patient identifier can be performed according to any prior art data matching or processing technique. The particular technique that is employed does not affect the teachings of the present invention.

Once the patient identifier manager has found the requested patient identifier, it returns it to the first patient domain, preferably by means of secure communication.

In a next step S3, the first patient domain utilizes the received patient identifier for associating medical patient data from one of the first and second patient domain with a patient identifier utilized by the other of the first and second patient domain. The method then ends.

In summary, this aspect of the present invention relates to a method of managing medical patient data in a healthcare system comprising a first patient domain, a second patient domain having domain-dedicated patient identifiers for identifying patients within the second patient domain and a patient identifier manager having patient-related data associatively stored with patient identifiers utilized by the second patient domain. The first patient domain then performs the following operations: i) providing patient-related data of a given patient; ii) requesting, from the patient identifier manager and based on the provided patient-related data, a patient identifier associated with the given patient and utilized by the second patient domain; and iii) associating medical patient data of the given patient from one of the first and second patient domain with a patient identifier associated with the given patient and utilized by the other of the first and second patient domain.

The principle of requesting a patient identifier for a given or current patient, which is utilized by an external domain, can of course be applied to a healthcare system that comprises more than two patient domains. For example, if the healthcare system comprises N different patient domains that utilize different patient identifiers, the patient identifier manager has access to the patient identifiers of M of these N patient domains, where 1≦M≦N−1 and N≧2. When the first patient domain request a patient identifier for e.g. a patient A at the patient identifier manager, the manager may return one such patient identifier for the patient A that is utilized by an external domain or it may return multiple such patient identifiers for the patient A utilized by different external patient domains.

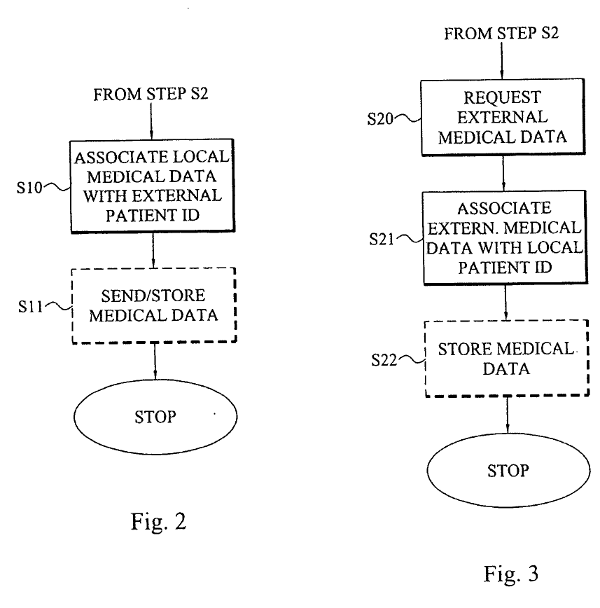

FIG. 2 is a flow diagram illustrating an implementation of the associating step S3 of FIG. 1 in more detail according to an embodiment of the present invention. The method continues from step S2 of FIG. 1. In a next step S10, the first patient domain associates local medical data originating from, or at least stored within, the first domain with the received (external) patient identifier. The association between the medical data and the patient identifier can be realized as described in the foregoing for the association between patient identifiers and patient-related data in the patient identifier manager.

As a consequence, medical and/or clinical data of the given patient from the first domain will be associated with an identifier of the given patient and utilized by an external (the second) patient domain. This means that medical data generated and found in the first domain is now, through the association with the external patient identifier that is also found in the patient identifier manager, accessible by the external domains. An external domain can use its own patient identifier directly as input in a request for medical data sent to the first patient domain or the patient identifier utilized in this external domain can be “translated” or mapped, typically in the patient identifier manager or at least based on information received from the identifier manager, to the patient identifier now associated with the requested medical data. As a result, a traditional data exchange procedure according to the IHE Technical Framework can now be performed also when the first domain is the source of medical data.

This embodiment of the present invention, thus, allows external domains to access medical data from a (isolated) patient domain, the patient identifiers of which are inaccessible for the external domains and other external units.

In an optional next step S11, the medical data and the received patient identifier is associatively stored in a storage location within the first patient domain and/or the medical data and patient identifier are sent, preferably through secure communication, to an external storage location for storage therein. The method then ends.

FIG. 3 is a flow diagram illustrating an implementation of the associating step S3 of FIG. 1 in more detail according to another embodiment of the present invention. The method continues from step S2 of FIG. 1. In a next step S20, the first patient domain requests, from the second domain and based on the received patient identifier, medical data of the given patient and found in the second domain. This request is preferably encrypted or otherwise securely transmitted to the second domain. In a typical scenario, the requested and received patient identifier that the first patient domain inserts in the medical data request is the patient identifier utilized by the second domain for the given patient. Otherwise, the first or second domain use this patient identifier in a traditional PIX query with the patient identifier manager for obtaining the correct patient identifier of the given patient and used in the second domain.

In either case, the second domain identifies and provides the requested medical data and returns it to the first domain, preferably through secure communication.

In a next step S21, the fast domain associates the received medical data with an identifier of the given patient and utilized locally within the first patient domain. The association between medical data and patient identifier can be realized according to the previously discussed techniques. The locally used identifier of the patient is typically already available for the physician or user when starting the procedure of the present invention for obtaining the medical data. Otherwise, the patient identifier can be obtained from e.g. a local identifier database based on patient-related or demographic data of the given patient, e.g. based on the same patient-related data that was provided in step S1 of FIG. 1.

A next optional step S22 associatively stores the medical data and the patient identifier locally within the first patient domain.

In this embodiment of the invention, medical data generated and/or stored in an external domain can be accessed by a (isolated) patient domain, the patient identifiers of which are not known by external domains and units. The association between the external medical data and the local domain-dedicated patient identifier allows a physician or other user in the first domain to subsequently access the patient data in a storage in the first domain by using only the local identifier of the patient.

The two embodiments of the invention described above and disclosed in FIGS. 2 and 3 may complement each other so that they may run in parallel or in series. However, in certain situations only one of the embodiments may be necessary, with the consequence that only that embodiment will be performed.

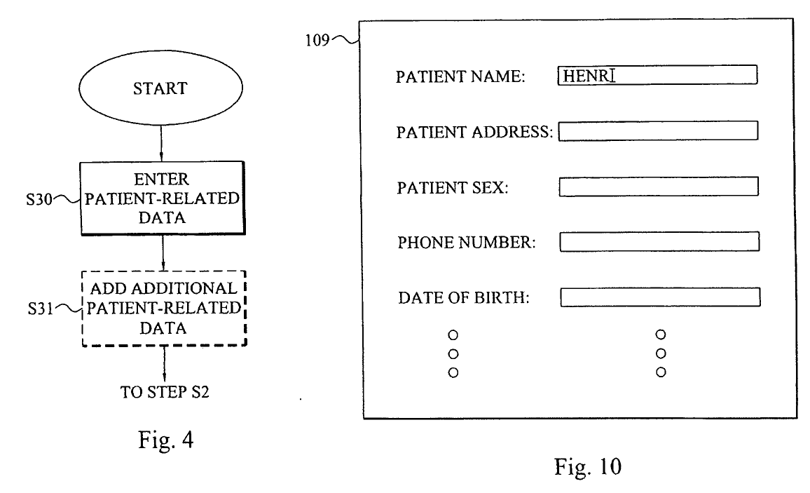

FIG. 4 is a flow diagram illustrating an implementation of the providing step S1 of FIG. 1 in more detail according to an embodiment of the present invention. The method starts in step S30, where a physician or user enters patient-related or demographic data describing the relevant patient in e.g. a search query or file. The patient-related data may be obtained from questioning the patient if he/she is available e.g. in person or via telephone, e-mail or another communication technique. The physician may also or alternatively obtain patient-related data from the file of the patient found in the first patient domain. Also other demographic sources can be employed according to the present invention. For example, in a programmer-IMD-based patient domain, demographic data can be uploaded from the IMD by the programmer. This uploaded data can be e.g. the name of the patient in which the IMD has been implemented, depending on the actual model of the IMD. The uploaded data may then automatically or manually be entered in the search query.

In an optional next step S31, additional patient-related data may be added from other sources. Such other sources can include computers and data managing units, at which the physician currently works and compiles the search query. These computers and data managing units may, at least temporarily, store some patient-related data that has previously been entered in the machine. This additional data can then be input into the search query manually by the physician or automatically. The method then continues to step S2 of FIG. 1.

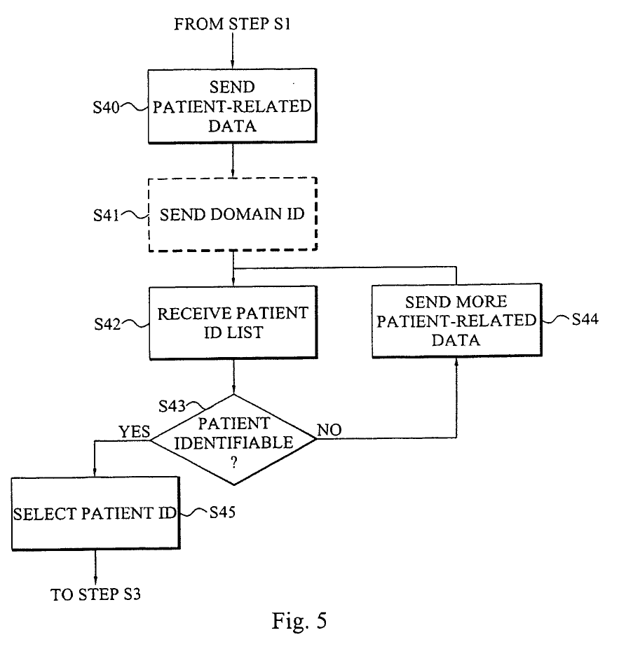

FIG. 5 is a flow diagram illustrating an implementation of the patient identifier requesting step S2 of FIG. 1 in more detail according to an embodiment of the present invention. The method continues from step S1 of FIG. 1. In a next step S40, the first patient domain sends the provided patient-related data to the patient identifier manager, preferably through secure communication. This communication can be realized by wired or wireless transmissions, e.g. using Internet or another communications network.

As was mentioned in the foregoing, in the case the healthcare system comprises more than two patient domains, the patient identifier manager can store more than one identifier for a given patient. In such a case, the first patient domain may specify that it wants the identifier of the given patient that is utilized by a specific patient domain or a specific subset of the external domains. The first patient domain then optionally sends to the patient identifier manager, in step S41 an identifier of the specific domain or identifiers of the domains that utilize(s) the requested patient identifier(s). For example, if the physician wants to access medical data of the given patient and found in a particular external domain, the request for patient identifier typically includes, in addition to the demographic data of the patient, the identifier of the external domain.

The domain identifier(s) is (are) preferably sent together with the patient-related data in the identifier request. In an alternative embodiment, the domain identifier(s) is (are) sent separately.

In a next step S42, the first patient domain receives a list of identifiers of patients that fulfill or match the previously sent patient-related data. The list ideally includes one patient identifier per external domain unless an external domain use two different identifiers for a given patient, the relevant patient is not customer in a particular external domain and/or only the patient identifier(s) utilized in a particular domain or a subset of the domains is (are) requested. If no identifiers of the patient can be found by the patient identifier manager, it preferably notifies the first patient domain accordingly in a message. If the patient/person is not a customer or patient in an external domain, e.g. a requested external domain, the patient identifier manager could return an identifier of the same patient/person but utilized by another external domain, if available, and/or notify the first domain that the request identifier is not available.

As was mentioned above, the patient identifier domain typically returns a list of identifiers for all patients in the relevant external domains that match the previously received patient-related data. Depending on what data that was sent it could be possible that more than one patient actually matches the given data. For example, if only the name of a person is used as patient-related data more than one patient, information of which is found in the identifier manager, may actually have that name and fulfill the provided demographic data. In the next step S43, it is investigated whether the correct patient can actually be identified in the provided list, i.e. whether the correct item (patient identifier) can be selected. In a typical scenario, the physician reviews the received list of candidate identifiers and investigates if any of these seems correct for the current patient. If the physician can unambiguously identify the patient from the list, the correct patient identifier or identifiers is (are) selected in a next step S45. The method then continues to step S3 of FIG. 1.

However, if the physician cannot unambiguously identify the correct patient, more patient-related data is preferably sent to the patient identifier manager in step S44 and a refined query involving the steps S42, S43 and S44 is performed until the correct patient identifier(s) can be selected.

The patient-related or demographic data that can be used according to the present invention could optionally be regarded as divided into at least two data sets. In such a case, demographic data of the first set is sent to the patient identifier manager in step S40. Only if the correct patient (identifier) cannot be identified in step S43, demographic data of the second set is sent to the identifier manager in step S44. This means that the second data set could be regarded as auxiliary data that only will be employed for identifying a current patient if the main patient data is insufficient or inadequate.

Note that the failure to identify the patient in S43 in the first run may not necessarily be due to that insufficient data has been provided to the patient identifier manager. The provided data can actually be incorrect, e.g. misspelled, which makes it harder for the patient identifier manager to return the correct patient identifier(s).

Table I below illustrates possible patient-related and demographic data that can be used according to the present invention. It should though be noted that the present invention is not limited to the particular examples given in Table I. A search query according to the invention can then include as its entry, the fields given in Table I or a portion thereof.

TABLE I
patient-related data
ELEMENT NAME

Patient Name
Mother's Maiden Name
Date/Time of Birth
Administrative Sex
Patient Alias
Race
Patient Address
Country Code
Phone Number - Home
Phone Number - Business
Primary Language
Marital Status
Religion
Patient Account Number
Social Security Number
Driver's License Number
Mother's Identifier
Ethnic Group
Birth Place
Multiple Birth Indicator
Birth Order
Citizenship
Veterans Military Status
Nationality
Patient Death Date and Time
Patient Death Indicator

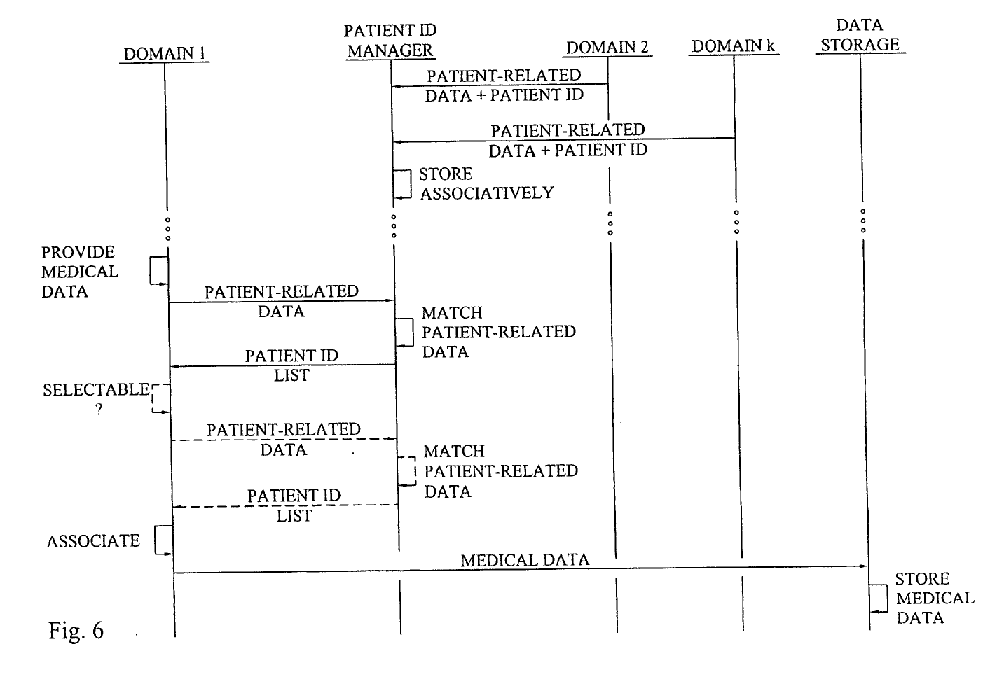

FIG. 6 is a signal diagram illustrating the communication between the possible actors in a healthcare system according to an embodiment of the present invention. In the figure, domain 1 is an isolated patient domain, the patient identifiers of which are only locally known and are not available to a patient identifier manager or external domains 2 to k.

In this data signaling, the external domains 2 to k send their patient identifiers together with patient-related data for the patients in the domains 2 to k to the patient identifier manager. This data transmission can be performed periodically, e.g. identifiers and demographic data of new patients are sent once every week or month. Alternatively, the domain-dedicated patient identifier and demographic data of a patient could be transmitted to the identifier manager when a new patient is registered or entered in the relevant domain 2 to k.

Once the patient identifier manager receives a new patient identifier it investigates whether the identifier regards a new patient for the manager or a patient, for which the manager already has at least one stored domain-dedicated identifier and patient-related data. In this investigation process, the manager employs the patient-related data that is accompanying the new patient identifier and investigates if any of the already stored patient-related data matches the received data. In this process, any techniques and procedures known in the art for data matching can be used according to the present invention. If no match is found, the received patient identifier is simply stored in the manager database associatively with the accompanying patient-related data. If a match is found, the received identifier is associatively stored with the corresponding identifier(s) of the same patient but utilized by the other domains. If some of patient-related data accompanying the identifier is not found in the database also the stored demographic data of the patient may be updated.

In domain 1, medical data of patient in the domain has been collected or provided. This medical data is now to be accessible for the external domains 2 to k by employing the procedure of the present invention. In this context, any medical data generation or collection known in the art can of course be used according to the invention. A physician or other user provides demographic data and other data describing the patient for which the medical data has been generated. This patient-related data is forwarded to the identifier manager, where a data matching process is started. This process basically corresponds to the data matching process described previously regarding entering new patient identifiers in the manager. The transmitted patient-related data may be accompanied by one or more domain identifiers that may be used by the manager when providing the requested patient identifier.

The patient identifier manager returns a message with typically a list of one or more patients and the identifier(s) of the patient(s) stored in the manager and which has (have) demographic data that matches the received patient-related data. The list could contain no identifier if no patient matches the demographic data, a single patient identifier, multiple identifiers of a single patient but utilized by different domains 2 to k or multiple identifiers of different identifiers utilized by a same or different domains 2 to k. If the domain 1 also sent one or more domain identifiers in the request to the patient identifier manager, the list preferably only includes those identifiers that are assigned to patients that matches the provided the demographic data and that are utilized by domain(s) 2 to k, which is (are) associated with the provided domain identifier(s).

The physician investigates the list in order to elucidate whether he/she can select a correct patient identifier. If this is not possible at a sufficient degree of probability/security, a refined search query is preferably performed, in which more and new demographic and patient-associated data is forwarded to the patient identifier manager. This new demographic data may be obtained from the same or different data source as the previously transmitted data.

A new matching process is then performed in the manager and a new or updated list of patient identifiers that preferably contains few identifiers and patients than the previous list is returned. The physician can repeat the query until a correct and suitable patient identifier can be selected. Thereafter, the correct patient identifier is associated with the medical data of the patient. This means that locally generated medical data is associated with an externally employed domain-dedicated patient identifier. The data and identifier can then be associatively stored in the domain 1 and/or forwarded to an external data storage. The medical data is now accessible for the external domains 2 to k due to the externally known patient identifier.

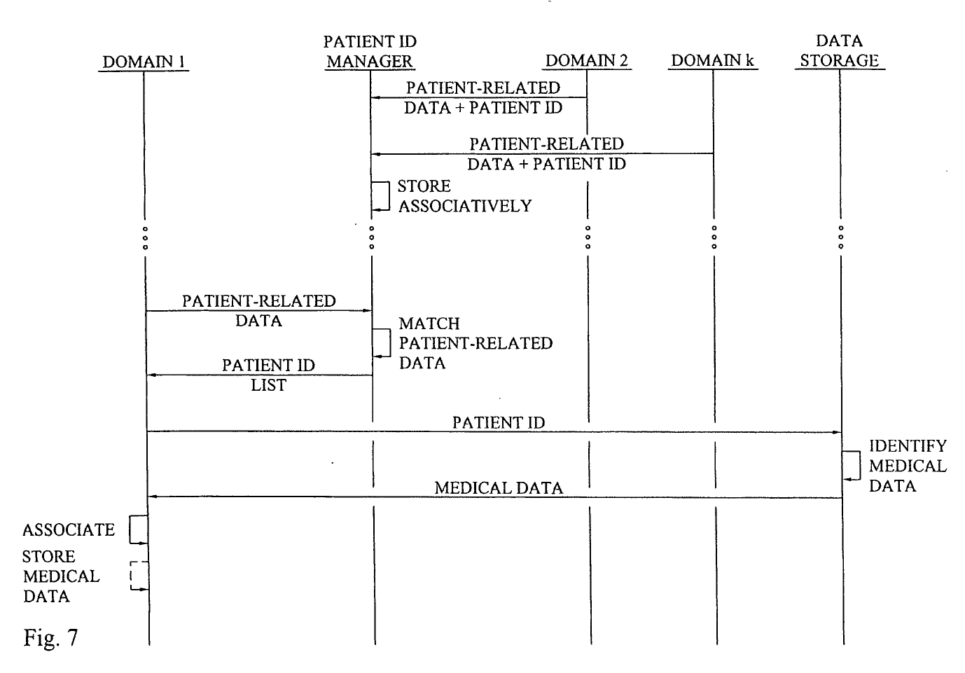

FIG. 7 is a signal diagram illustrating the communication between the possible actors in a healthcare system according to another embodiment of the present invention. The generation of a patient identifier and patient-related data storage in the patient identifier manager is similar to above and is not described further. Furthermore, the procedure of requesting an external patient identifier according to the present invention may be performed in the same manner as was discussed in connection with FIG. 6 and is not repeated herein.

Once the physician or other user has received and selected a correct patient identifier, it uses this identifier for composing a request for medical data of the identifier associated with the patient and found in an external storage. In the figure, this data storage has been illustrated as a unit separate from the domains 1 to k in the system. However, the storage may likewise be arranged in one of the external domains 2 to k. A data storage managing unit retrieves the patient identifier from the data request and identifies, by means of the identifier, the requested medical data that is returned to the physician.

In domain 1, the received medical data of the patient is associated with the local domain-dedicated identifier of the patient that is utilized within the domain 1. The data and identifier is then typically associatively stored in a storage facility in the domain 1. The association of the data to this identifier allows a subsequent local identification and retrieval of the data within the domain 1.

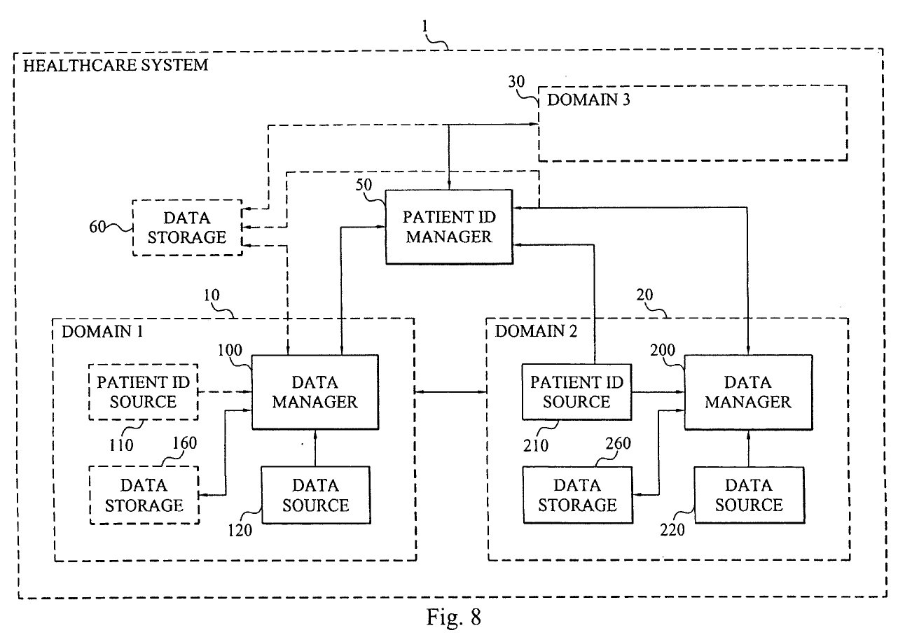

FIG. 8 is a schematic overview of a healthcare system 1 according to an embodiment of the present invention. The system 1 comprises a number of patient domains 10, 20, 30, non-limitedly exemplified by three such domains 10, 20, 30 in the figure. In addition, the healthcare system 1 comprises a central patient identifier manager 50 that has capacity to communicate with the domains 10, 20, 30, preferably by secure communication.

According to the present invention, the patient identifier manager 50 stores demographic data of patient and the corresponding patient identifiers utilized by the second 20 and possibly the third 30 patient domain in the system 1 but not the first domain 10.

A patient domain 10, 20 has a data manager 100, 200 that embodies functionality for communicating with the patient identifier manager 50 and preferably also with the other patient domains 10, 20, 30. This data manager 100, 200 manages the medical data collected and stored within the domain 10, 20. Thus, medical and clinical data is generated or provided in a data source 120, 220 in the domain 10, 20. This data source 120, 220 could be any medical machine or other medical data recording equipment that can measure, generate and/or compile medical and clinical data of a patient. The medical data from the source 120, 220 is typically provided to the connected data manager 100, 200, which associates the data with an identifier of the patient that is utilized within the domain 10, 20. This patient identifier can be a previously assigned identifier for the patient, or if the patient visits the patient domain 10, 20 for the first time, it can be a new patient identifier provided from a patient identifier source 110, 210 connected to the data manager 100, 200. The data manager 100, 200 typically stores the medical data and the patient identifier in a local data storage 160, 260 within the domain 10, 20 for a later retrieval by the same or a different physician within the domain 10, 20.

The data manager 100, 200 also manages the exchange and request of medical data between the different domains 10, 20. However, such a data exchange and requesting will not be realizable employing the PIX query and data exchange of IHE and other prior art procedures in a healthcare system 1, in which the patient identifier manager 50 does not have access to the patient identifiers of all domains 10, 20, 30.

The healthcare system 1 may also optionally have a central data storage 60 for storing medical data collected in the domains 10.

The patient identifier source 210 of the second domain 20 is further configured for, periodically, intermittently and/or upon a triggering event (e.g. once a new patient visits the domain 20), transmitting its new patient identifiers and demographic data to the patient identifier manager 50 for storage. The patient identifiers utilized by this second domain 20 could be social security number, national identification number or a healthcare provider-issued patient number.

In clear contrast to the second domain 20, the patient identifier source 110 of the first domain 10 does not, e.g. due to regulatory or practical issues, provide its new patient identifiers to the patient identifier manager 50. Typical examples of such patient identifiers that are not suitable or even permitted for external distribution include model and serial number of IMDs.

When applying the teachings of the present invention as a complement to the PIX procedure of the IHE Technical Framework, those skilled in the art will recognize that the patient identifier manager 50 of the invention also has the role of PIX manager as defined in the Technical Framework and that the data manager 100, 200 of the invention also has the role of PIX consumer as defined in the Technical Framework.

As is evident to those skilled in the art based on the present description, the present invention can be used as a complement to the procedures in IHE Technical Framework for managing those situations (with isolated patient domains) that this prior data exchange scheme cannot handle or cannot effectively handle. However, the present invention is not limited to IHE-implementing healthcare systems but can generally be applied to any domain-based healthcare system, in which medical data and patient identifiers should be distributed or exchanged between the involved patient domains.

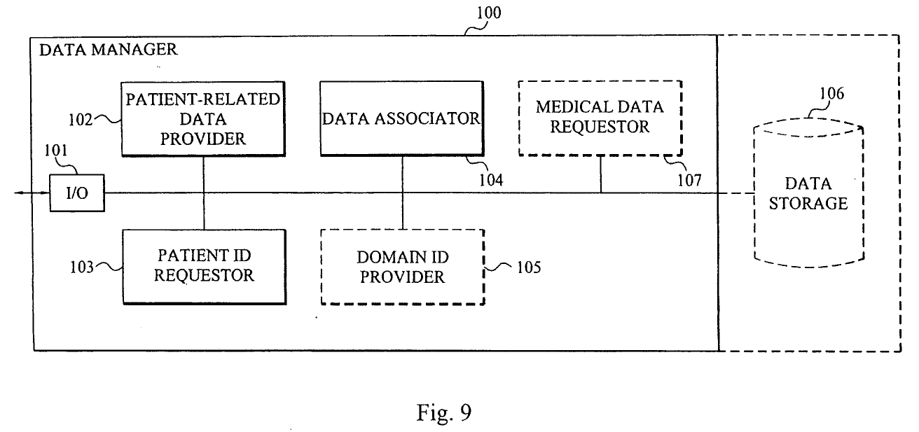

FIG. 9 is a schematic block diagram of an embodiment of a data manager 100 according to the present invention. This data manager 100 may, for example, be implemented in the first domain 10 of the healthcare system 1 in FIG. 8.

The data manager 100 includes a general input and output (I/O) unit or module 101 for managing the communication with external units, including external patient domains, a patient identifier manager and possibly an external data storage. This I/O module 101 is preferably arranged for performing secure communication with the external units since at least some of the communicated data, including medical and clinical data and patient identifiers, may be sensitive data. The I/O module 101 is in particular implemented for requesting a patient identifier from a patient identifier manager and receiving the requested identifier, possible as a list containing multiple identifiers of candidate patients. The I/O module 101 is also used by the data manager 100 for requesting medical patient data from other domains and when sending medical data to such external domains or storage facilities.

A module for providing patient-related or demographic data 102 is arranged in the data manager 100 for providing patient-related data that is to be transmitted in a patient identifier request to the identifier manager. This data provider 102 can use different demographic sources for obtaining the relevant patient-related data, depending on the actual implementation of the data manager 100. For example, the data provider 102 can receive the demographic data, possible via the I/O module 101, from a user interface. In this context, a physician or other user may enter patient-related data by means of a keyboard, by scanning a patient's wristband or by some other well-known user input device. The data provider 102 may also, or alternatively, obtain some of the patient-related data from a connected data storage 106 that may be implemented in the data manager 100 or externally but then accessible for the data provider 102. However, due to the extensive regulations that are present for storage of demographic and patient-related data, a patient domain may be prohibited to have longterm storage of such data. However, it could be possible that demographic data may be at least temporarily stored in a memory 106 for the purpose of (medical) data recording of a patient. In such a case, the data provider 102 can retrieve the relevant demographic data from the memory 106.

In the case the data manager is implemented in a programmer or is in communication with a programmer that in turn can upload data from an IMD, demographic data may actually be stored in the IMD and uploaded therefrom. The data provider 102 could then use this uploaded data as patient-related data according to the present invention.

The patient-related data compiled by the data provider 102 is forwarded or brought to a patient identifier requester 103. This identifier requestor 103 uses the provided patient-related data and composes a request message that is sent by the I/O module 101 to the patient identifier manager. The request message can be in the form of, or at least include, a search query having different demographic entries. This search query may be managed and compiled by the data provider 102 or the identifier requester 103. FIG. 10 schematically illustrates how such a search query 109 may look like. As is seen in the figure, the query 109 typically includes a number of entries, schematically and non-limitedly exemplified by “patient name”, “patient address”, “patient sex”, “patient's phone number” and “patient's data of birth”. An input line is provided next to each such element name. The physician may then, by means of a user input device, enter the correct demographic data of the patient in these lines. Also an automatic entry of demographic data from data storages, IMDs, etc. is also possible.

The identifier requester 103 may also receive input data that is to be included in the request message from a domain identifier provider 105 implemented in the data manager 100. This domain identifier provider 105 generates an identifier of the patient domain or those patient domains that utilize(s) the identifier(s) of the patient that is (are) to be requested. The identifier provider 105 typically generates the domain identifier(s) based on input information from e.g. a physician that selects which domain(s) that is (are) desired.

The identifier requestor 103 sends the request message by means of the I/O module 101 to the patient identifier manager, which returns a list of identifiers of those patients that match the patient-related data included in the request message. The identifiers may be limited to patient identifiers utilized by patient domains associated with the domain identifiers included in the request message.

The received list is typically displayed at a display screen to allow a physician or user to confirm that the received identifier(s) are relevant or to select one of the received identifiers. If the correct identifier for the current patient cannot be selected, the data provider typically provides more patient-related data, possibly from a new data source, a refined query or request message including the additional patient-related data is composed by the identifier requester 103 and sent to the identifier manager.

The final selected patient identifier, or possibly identifiers, or sole patient identifier, if the return message from the patient identifier manager only included a single identifier, is brought to a data associating module 104. This data associator 104 is configured for associating a locally (externally) utilized identifier of a patient with medical data of the patient originated externally (locally) by employing the provided patient identifier.

In a preferred embodiment, the data associator 104 receives or extracts medical data of the patient from e.g. a local data storage 106 or receives it directly from the medical appliance that generated the medical data. This local medical data is then associated by the data associator 104 with the patient identifier received from the identifier manager. This association can be realized by adding the identifier to the same file as the medical data, include the identifier in a dedicated header field in the medical data file or provide some other association or link between the medical data and the identifier. Note that this local medical data may already be associated with the identifier of the patient that is utilized locally within the patient domain, in which the data manager 100 is implemented. In such a case, the medical data will be associated with both a local patient identifier, which allows a simple identification and local retrieval of the data within the domain, and an external patient identifier, which allows external units to request and access the data.

The medical data and identifier is then typically brought to a data storage 106, which may be implemented locally within the domain or externally.

In another preferred embodiment of the invention, the received and correct patient identifier is forwarded to a medical data requester 107 of the data manager 100. The data requester 107 composes a request message for medical or clinical data of the patient identified by the received patient identifier. This data request is sent via the I/O module 101 to the external patient domain that stores the requested medical data. Since the patient identifier included in the request message is an identifier known to the healthcare system, i.e. being an identifier utilized by the external domain itself or at least stored in the patient identifier manager, the requested medical data can be simply identified.

The medical data is returned to the first patient domain and its data manager 100, where it is brought to the data associator 104. The associator 104 associates a locally utilized identifier of the patient with the received medical data for allowing an efficient and simple tool for subsequent access of the medical data within the patient domain. The (external) medical data and the associated (local) patient identifier are then typically stored in a local storage location 106.

In summary, with reference to FIGS. 8 and 9, this aspect of the present invention an arrangement 100 for managing medical patient data in a healthcare system 1 having a first patient domain 10, a second patient domain 20 having domain-dedicated patient identifiers for identifying patients within the second patient domain 20 and a patient identifier manager 50 having patient-related data associatively stored with patient identifiers utilized by the second patient domain 20. The arrangement 100 is implemented in said first patient domain 10 and includes a data source 102 for providing patient-related data of a given patient; ii) an identifier requester 103 for requesting, from the patient identifier manager 50 and based on the provided patient-related data, a patient identifier associated with the given patient and utilized by the second patient domain 20; and means an association unit 104 for associating medical patient data of the given patient from one of the first 10 and second 20 patient domains with a patient identifier associated with the given patient and utilized by the other of the first 10 and second 20 patient domain.

The modules 101 to 105 and 107 of the data manager 100 may be implemented as software, hardware or a combination thereof. The modules 101 to 107 may all be implemented in the data manager. However, a distributed implementation is also possible, with the modules 101 to 107 provided elsewhere in the patient domain.

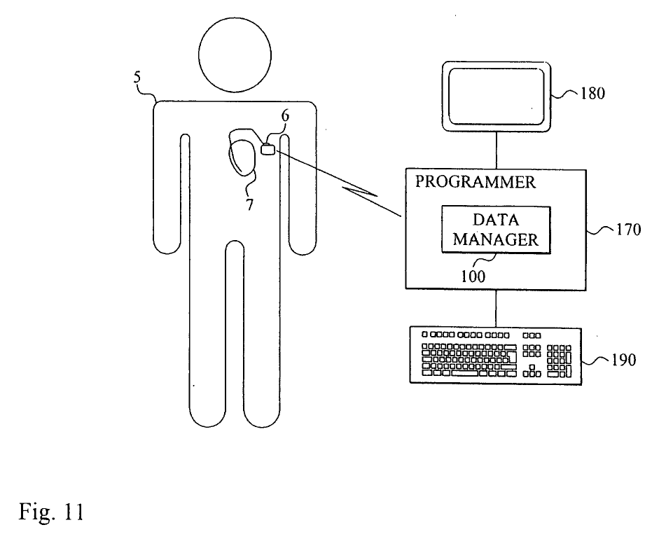

FIG. 11 is a schematic example of a portion of a patient domain implementing the present invention. This patient domain comprises at least one IMD 6 implanted in a patient or subject 5 in need thereof. In FIG. 11, the IMD 6 is illustrated as a device that monitors and/or provides therapy to the heart 7 of the patient 5, such as a pacemaker, defibrillator or cardioverter. However, also other types of IMDs besides cardiac-associated IMDs, such as drug pumps, neurological stimulators, physical signal recorders, oxygen sensors, or the like could be utilized within the patient domain.

The IMD 6 preferably includes functionality for collecting and sampling physiological and diagnostic data, such as intracardiac electrogram (IEGM) and/or event marker data in the case of a cardiac-associated IMD. This physiological data and also data representing operational parameters and settings of the IMD 6 might be useful for a clinician and is therefore preferably communicated to an external device 170. As a consequence, the IMD 6 typically includes a communications module to communicate with the external device 170 via a wireless link. This wireless transmission could generally be realized using any known non-invasive wireless technique usable in medical applications. A preferred example is radio frequency (RF) telemetry, in which radio packets carrying data are transmitted over the wireless link between the IMD 5 and the external device 170.

The external device 170 is typically denoted programmer in the art. According to a preferred embodiment of the present invention, the data manager 100 of this IMD-programmer-based patient domain is housed within the programmer 170. In an alternative preferred embodiment, the data manager 100 is implemented in a unit that can communicate (wired or wireless communication) with the programmer 170.

The programmer 170 may receive diagnostic and medical data from the IMD 6 that can, due to the data manager 100 according to the present invention be associated with an externally employed identifier of the patient 5. Within the current domain, the model and serial number of the IMD 6 is typically utilized as identifier of the patient 5. Though, this type of identifier is suitable for the purposes of this patient domain, the model and serial number is seldom known to any external units or domains and is consequently typically not found in the patient identifier manager. As a consequence, implementing a data manager 100 according to the present invention within a programmer or at least in connection with a programmer 170 solves the isolation problem for the IMD-programmer-based domain that is otherwise a major disadvantage in the prior art healthcare systems.

In a preferred implementation, the programmer 170 includes or is connected to a user input device, represented by a keyboard 190 in the figure. This keyboard 190 allows a physician to enter e.g. patient-related data in search query compiled by the data manager 100. A display screen 180 may also be present within or connected to the programmer 170 for e.g. displaying a list of candidate patient identifiers that the data manager 100 has received following a request for patient identifier at the patient identifier manager. The display screen 180 may of course also be employed for displaying diagnostic and medical data, both from the IMD 6 and requested from an external domain according to the invention.

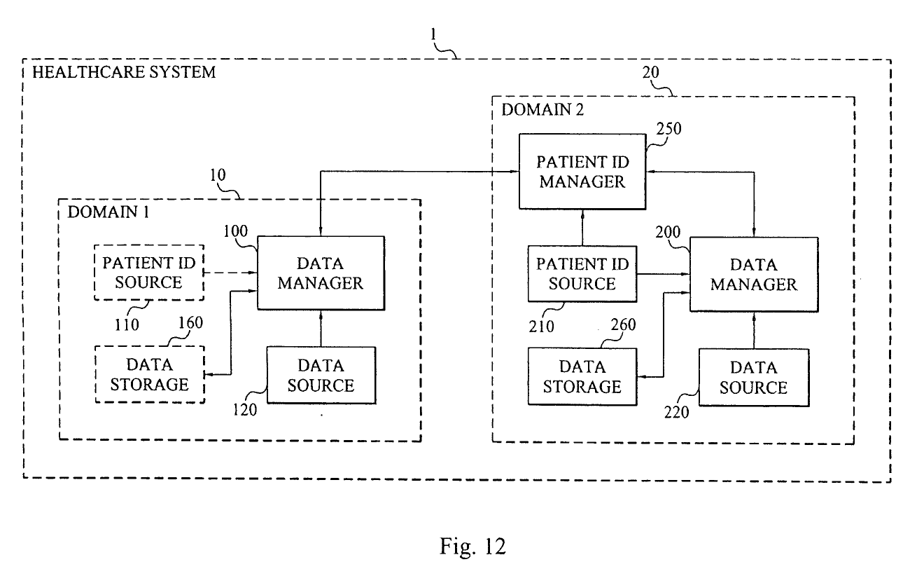

FIG. 12 is a schematic overview of a healthcare system 1 according to another embodiment of the present invention. The main difference between this healthcare system embodiment and the embodiment disclosed in FIG. 8 is that the patient identifier manager 250 is now implemented within one of the external patient domains 20. The operation of this embodiment is similar to the previously described one. This figure should merely illustrate that the present invention can be applied to different system designs, regardless of where e.g. the patient identifier manager 250 is implemented.

Although modifications and changes may be suggested by those skilled in the art, it is the intention of the inventors to embody within the patent warranted heron all changes and modifications as reasonably and properly come within the scope of their contribution to the art.

1. A method of managing medical patient data in a healthcare system comprising a first patient domain, a second patient domain having domain-dedicated patient identifiers for identifying patients within said second patient domain and a patient identifier manager having patient-related data associatively stored with patient-identifiers utilized by said second patient domain, said method comprising, in said first patient domain:
providing patient-related data of a given patient;
requesting, from said patient identifier manager and based on said provided patient-related data, a patient identifier associated with said given patient (and utilized by said second patient domain; and
associating medical data of said given patient (with said requested patient identifier.

2-3. (canceled)

4. A method of managing medical patient data in a healthcare system comprising a first patient domain having domain-dedicated patient identifiers for locally identifying patients within said first patient domain, a second patient domain having domain-dedicated patient identifiers for identifying patients (within said second patient domain and a patient identifier manager having patient-related data associatively stored with patient identifiers utilized by said second patient domain, said method comprising, in said first patient domain:
providing patient-related data of a given patient (5);
requesting, from said patient identifier manager and based on said provided patient-related data, a patient identifier associated with said given patient and utilized by said second patient domain;
requesting, from an external medical data storage and based on said requested patient identifier, medical data of said given patient; and
associating said requested medical data with a patient identifier associated with said given patient and utilized locally within said first patient domain.

5. The method according to claim 4, wherein said healthcare system comprises said first patient domain, said second patient domain and a third patient domain, said patient identifier manager having patient-related data associatively stored with patient identifiers utilized by said second and said third patient domains, said method further comprising providing, in said first patient domain, a domain identifier associated with said second or third patient domain, and said requesting step comprises requesting, based on said provided patient-related data and said domain identifier, a patient identifier associated with said given patient and utilized by the patient domain associated with said domain identifier.

6. The method according to claim 5, comprising arranging said patient identifier manager said second patient domain.

7. The method according to claim 5, comprising arranging said patient identifier manager in said healthcare system for secure communication with said first patient domain and said second patient domain.

8. The method according to claim 4, comprising providing a patient identifier source n said patient domain having domain-dedicated patient identifiers for identifying patients within said patient domain and providing a patient identifier requester for requesting, from said patient identifier manager, patient identifiers utilized by external patient domains.

9. The method according to claim 8, comprising, in said patient identifier source of said first patient domain storing serial and model numbers of medical devices implanted in patients and comprising embodying said patient identifier requester a programmer configured for communication with said implanted medical devices and communication with said patient identifier manager.

10. The method according to claim 9 comprising, said providing said patient related data by:
uploading at least a portion of said patient-related data from a medical device implanted in said given patient; and
entering said uploaded patient-related data in a search query in said patient identifier requester.

11. (canceled)

12. The method according to any of the claim 8, comprising entering said patient-related data in a search query in said patient identifier requester.

13. The method according to any of the claim 8, comprising said patient identifier requester inserting, in a search query and based on entered patient-related data of said given patient, further patient-related data of said given patient stored in connection with said patient identifier requester.

14. The method according to said patient identifier by:
sending said patient-related data to said patient identifier manager;
receiving, from said patient identifier manager, a list of patient identifiers matching said patient-related data; and
selecting said patient identifier from said list.

15. The method according to claim 14, comprising sending more patient-related data of said given patient until said patient identifier associated with said given patient can be unambiguously identified from said received list.

16. The method according to claim 15, comprising sending step said patient related data by:
sending initial patient-related data from a first set of patient-related data to said patient identifier manager; and
sending said more patient-related data, until said patient identifier associated with said given patient can be unambiguously identified from said received list, from another set of patient-related data to said patient identifier manager.

17. (canceled)

18. An arrangement for managing medical patient data in a healthcare system, said healthcare system 1 comprising a first patient domain, a second patient domain (having domain-dedicated patient identifiers for identifying patients (within said second patient domain and a patient identifier manager having patient-related data associatively stored with patient identifiers utilized by said second patient domain, said arrangement having implemented in said first patient domain and comprising:
a source of patient-related data of a given patient;
an identifier requester configured to request, from said patient identifier manager and based on said provided patient-related data, a patient identifier associated with said given patient and utilized by said second patient domain; and
an association unit configured to associate medical data of said given patient with said requested patient identifier.

19. The arrangement according to claim 18, comprising a forwarding unit configured to forward said medical patient data associated with said patient identifier to an external medical data storage.

20. An arrangement for managing medical patient data in a healthcare system, said healthcare system comprising a first patient domain having domain-dedicated patient identifiers for locally identifying patients within said first patient domain, a second patient domain (having domain-dedicated patient identifiers for identifying patients (within said second patient domain and a patient identifier manager having patient-related data associatively stored with patient identifiers utilized by said second patient domain, said arrangement is implemented in said first patient domain (and comprising:
a source of patient-related data of a given patient;
an identifier requester configured to request, from said patient identifier manager and based on said provided patient-related data, a patient identifier associated with said given patient and utilized by said second patient domain;
a data requester configured to request, from an external medical data storage and based on said requested patient identifier, medical data of said given patient; and
association unit configured to associate said requested medical data with a patient identifier associated with said given patient and utilized locally within said first patient domain.

21. The arrangement according to claim 20, wherein said healthcare system comprises said first patient domain, said second patient domain and a third patient domain, said patient identifier manager having patient-related data associatively stored with patient identifiers utilized by said second (M and said third patient domains, said arrangement further comprising means a source of a domain identifier associated with said second or third patient domain, and wherein said identifier requestor is configured to request, based on said provided patient-related data and said domain identifier, a patient identifier associated with said given patient and utilized by the patient domain associated with said domain identifier.

22. The arrangement according to claim 20, wherein said source comprises:
a user interface for receiving patient-related data; and
an input unit for entering said patient-related data in a search query.

23. The arrangement according to claim 20, wherein said source is configured to upload at least a portion of said patient-related data from a medical device implanted in said given patient and to enter said uploaded patient-related data in a search query.

24. The arrangement according to claim 23, wherein said input unit is configured to insert, in said search query, further patient-related data of said patient stored in a memory accessible in said first patient domain based on entered said patient-related data received by said user interface.

25. The arrangement according to claim 20, wherein said identifier requester is configured to send said patient-related data to said patient identifier manager, for receiving, from said patient identifier manager, a list of patient identifiers matching said patient-related data, and for selecting said patient identifier from said list.

26. The arrangement according to claim 25, wherein said identifier requestor is configured to send more patient-related data of said patient until said patient identifier associated with said given patient can be unambiguously identified from said list.

27. The arrangement according to claim 26, wherein said identifier requester is configured to send initial patient-related data from a first set of patient-related data to said patient identifier manager and to send, until said patient identifier associated with said given patient can be unambiguously identified from said list, patient-related data from another set of said move patient-related data so said patient identifier manager

28-29. (canceled)

30. A method of managing medical patient data in a healthcare system comprising a first patient domain, a second patient domain (having domain-dedicated patient identifiers for identifying patients within said second patient domain and a patient identifier manager having patient-related data associatively stored with patient identifiers utilized by said second patient domain, said method comprising:
providing, in said first patient domain, patient-related data of a given patient;
sending said patient-related data from said first patient domain to said patient identifier manager;
said patient identifier manager identifying at least one patient identifier associated with said given patient and having associated patient-related data that matches said patient-related data received from said first patient domain;
said patient identifier manager transmitting said identified at least one patient identifier to said first patient domain; and
associating, in said first patient domain, medical data of said given patient with said at least one patient identifier.

31. A method of managing medical patient data in a healthcare system comprising a first patient domain, a second patient domain (having domain-dedicated patient identifiers for identifying patients within said second patient domain (and a patient identifier manager having patient-related data associatively stored with patient identifiers utilized by said second patient domain, said method is characterized by:
providing, in said first patient domain, patient-related data of a given patient;
sending said patient-related data from said first patient domain to said patient identifier manager;
said patient identifier manager identifying at least one patient identifier associated with said given patient and having associated patient-related data that matches said patient-related data received from said first patient domain;
said patient identifier manager transmitting said identified at least one patient identifier to said first patient domain;
sending said at least one patient identifier to an external medical data storage;
returning from said external medical data storage medical data of said given patient; and
associating, in said first patient domain, said returned medical data with a patient identifier associated with said given patient and utilized locally within said first patient domain.
